(19) United States
(12) Patent Application Publication
(10) Pub. No.: US 2021/0336680 A1
(43) Pub. Date: Oct. 28, 2021

(54) Physical Uplink Control Channel Power Control for Beam Diversity

(71) Applicants: Nokia Technologies Oy, Espoo (FI); Nokia of America Corporation, Murray Hill, NJ (US)

(72) Inventors: Dan Park, Suji gu (KR); Yi Zhang, Beijing (CN); De Shan Miao, Beijing (CN); Emad Farag, Murray Hill, NJ (US)

(21) Appl. No.: 16/625,152

(22) PCT Filed: Jun. 26, 2018
(86) PCT No.: PCT/US2018/039498

§ 371 Date: Dec. 20, 2019

Related U.S. Application Data
(60) Provisional application No. 62/524,991, filed on Jun. 26, 2017.

(51) Int. Cl. H04B 7/06; H04B 7/08; H04W 52/14; H04W 52/42

(52) U.S. Cl. CPC H04B 7/0695; H04B 7/088; H04W 72/042; H04W 52/42; H04W 52/146

(57) ABSTRACT

Certain embodiments may relate to communication systems, and, for example, some embodiments may relate to beamforming techniques. According to an embodiment, a method may include, for each PDCCH search space candidate, one or more UE beams may be configured and/or assigned that correspond to one or more of the configured beam pairs. For each PDCCH search space candidate, one or more beam pairs, based on one or more corresponding downlink RS for beam management, may correspond to a configured UE beam. The UE may detect a PDCCH. Upon detecting a PDCCH, the UE can identify one or more configured beam pairs or a default beam pair within the PDCCH search space candidates.

### CROSS REFERENCE TO RELATED APPLICATION

This application claims the benefit of U.S. Provisional Application No. 62/524,991, filed Jun. 26, 2017. The entire content of the above-referenced application is hereby incorporated by reference.

### BACKGROUND

### Field

Certain embodiments may relate to communication systems, and, for example, some embodiments may relate to beamforming techniques. In particular, beam diversity schemes may be used in a communication system, such as a Long-Term Evolution (LTE) network, 5th generation (5G) mobile network, or next-generation network system, to provide physical uplink control channel power control.

### Description of the Related Art

In a communication system, such as a Long-Term Evolution (LTE) network or 5th generation (5G) mobile network or next-generation network system, beamforming techniques may be used to improve signal reliability and performance. Beamforming techniques may use a transmission and reception signal for various channels and signals that deliver essential system information or user equipment (UE) dedicated control information. The accuracy of beam alignment in a beamformed system is critical to obtain system reliability and support sufficiency performance, including capacity. However, challenges may be encountered in achieving sufficient resolution or accuracy of information for channel status, including beam alignment information.

Beam diversity schemes may be used to support successful transmission of a physical downlink control channel (PDCCH). When UE successfully receives a PDCCH with a particular UE beam, the UE may associate the UE beam with physical uplink control channel (PUCCH) transmissions since similar beams may be used for downlink and uplink transmissions.

In some embodiments, a particular next generation node B (gNB) beam and UE beam pair used for PDCCH transmission may be known to the UE. Since downlink path loss may be measured separately for multiple beam pairs, UE may determine the path loss, and utilize the determined path loss for PUCCH power control improvement.

### SUMMARY

In accordance with an example, an apparatus may include at least one processor and at least one memory including computer program code. The at least one memory and the computer program code may be configured to, with the at least one processor, cause the apparatus to at least, for each PDCCH search space candidate, configure one or more of the beam pairs based on one or more corresponding downlink RS for beam management. The at least one memory and the computer program code may be further configured to, with the at least one processor, cause the apparatus to at least, for each PDCCH search space candidate, assign one or more UE beams that correspond to one or more of the configured beam pairs based on one or more corresponding downlink RS for beam management. For each PDCCH search space candidate, one or more beam pairs may correspond to a configured UE beam. The at least one memory and the computer program code may be further configured to, with the at least one processor, cause the apparatus to at least detect a PDCCH. The at least one memory and the computer program code may be further configured to, with the at least one processor, cause the apparatus to at least, upon detecting a PDCCH, identify one or more beam pairs within the PDCCH search space candidates. For each PDCCH search space candidate, one or more beam pairs, based on one or more corresponding downlink RS for beam management, correspond to a UE beam.

In accordance with an example, an apparatus may include means for, for each PDCCH search space candidate, configuring one or more of the beam pairs based on one or more corresponding downlink RS for beam management. The apparatus may further include means for, for each PDCCH search space candidate, assigning one or more UE beams that correspond to one or more of the configured beam pairs based on one or more corresponding downlink RS for beam management. For each PDCCH search space candidate, one or more beam pairs may correspond to a configured UE beam. The apparatus may further include means for detecting a PDCCH. The apparatus may further include means for, upon detecting a PDCCH, identifying one or more beam pairs, based on one or more corresponding downlink RS for beam management, within the PDCCH search space candidates. For each PDCCH search space candidate, one or more beam pairs, based on one or more corresponding downlink RS for beam management, correspond to a UE beam.

In accordance with an example, a non-transitory computer readable medium may, in certain examples, be encoded with instructions that may, when executed in hardware, perform a process. The process may include a method that may, for each PDCCH search space candidate, configure one or more of the beam pairs based on one or more corresponding downlink RS for beam management. The process may further include a method that may, for each PDCCH search space candidate, assign one or more UE beams that correspond to one or more of the configured beam pairs based on one or more corresponding downlink RS for beam management. The process may further include a method that may detect a PDCCH. The process may further include a method that may, upon detecting a PDCCH, identify, based on one or more corresponding downlink RS for beam management, one or more default beam pairs, based on one or more corresponding downlink RS for beam management, within the PDCCH search space candidates. For each PDCCH search space candidate, one or more beam pairs, based on one or more corresponding downlink RS for beam management, correspond to a UE beam.

In accordance with an example, a computer program product may, according to certain examples, have instructions encoded for performing a process. The process may include a method that may, for each PDCCH search space candidate, configure one or more of the beam pairs based on one or more corresponding downlink RS for beam management. The process may further include a method that may, for each PDCCH search space candidate, assign one or more UE beams that correspond to one or more of the configured beam pairs based on one or more corresponding downlink RS for beam management. The process may further include a method that may detect a PDCCH. The process may further include a method that may, upon detecting a PDCCH, identify one or more beam pairs, based on one or more corresponding downlink RS for beam management, within the PDCCH search space candidates. For each PDCCH search space candidate, one or more beam pairs, based on one or more corresponding downlink RS for beam management, correspond to a UE beam.

In accordance with an example, an apparatus may include circuitry configured to, for each PDCCH search space candidate, configure one or more of the beam pairs based on one or more corresponding downlink RS for beam management. The apparatus may further include circuitry configured to, for each PDCCH search space candidate, assign one or more UE beams that correspond to one or more of the configured beam pairs based on one or more corresponding downlink RS for beam management. The apparatus may further include circuitry configured to detect a PDCCH. The apparatus may further include circuitry configured to, upon detecting a PDCCH, identify one or more beam pairs, based on one or more corresponding downlink RS for beam management, within the PDCCH search space candidates. For each PDCCH search space candidate, one or more beam pairs, based on one or more corresponding downlink RS for beam management, correspond to a UE beam.

In accordance with an example, a method may include, for each PDCCH search space candidate, configuring one or more of the beam pairs based on one or more corresponding downlink RS for beam management. The method may also include, for each PDCCH search space candidate, assigning one or more UE beams that correspond to one or more of the configured beam pairs, based on one or more corresponding downlink RS for beam management. The method may also include detecting a PDCCH. The method may also include, upon detecting a PDCCH, identifying one or more beam pairs, based on one or more corresponding downlink RS for beam management, within the PDCCH search space candidates. For each PDCCH search space candidate, one or more beam pairs, based on one or more corresponding downlink RS for beam management, correspond to a UE beam.

In a variant, one or more UE beams of the one or more configured PDCCH beam pairs may be assigned to and/or configured with one or more PDCCH search space candidates.

In a variant, a beam pair corresponding to a configured UE beam may be configured as a default beam pair for path loss measurement.

In a variant, one or more beam pairs which provide the smallest and/or largest path loss may be configured as a default beam pair.

In accordance with an example, an apparatus may include at least one processor and at least one memory including computer program code. The at least one memory and the computer program code may be configured to, with the at least one processor, cause the apparatus to at least configure one or more beam pairs for PDCCH based upon a corresponding downlink RS for beam management. The at least one memory and the computer program code may be further configured to, with the at least one processor, cause the apparatus to at least assign one or more user equipment beams which correspond to one or more configured beam pairs, based on one or more corresponding downlink RS for beam management. The at least one memory and the computer program code may be further configured to, with the at least one processor, cause the apparatus to at least, upon detecting a PDCCH within a search space candidate with a particular port or ports, identify one or more default beam pairs, based on one or more corresponding downlink RS for beam management, within the PDCCH search space candidates. The at least one memory and the computer program code may be further configured to, with the at least one processor, cause the apparatus to at least, evaluate path loss for PUCCH transmission based upon the one or more RS corresponding to the one or more beam pairs.

In accordance with an example, an apparatus may include means for configuring one or more beam pairs for PDCCH based upon a corresponding downlink RS for beam management. The apparatus may further include means for assigning one or more user equipment beams which correspond to one or more configured beam pairs, based on one or more corresponding downlink RS for beam management. The apparatus may further include means for, upon detecting a PDCCH within a search space candidate with a particular port or ports, identifying one or more default beam pairs, based on one or more corresponding downlink RS for beam management, within the PDCCH search space candidates. The apparatus may further include means for evaluating path loss for PUCCH transmission based upon the one or more RS corresponding to the one or more beam pairs.

In accordance with an example, a non-transitory computer readable medium may, in certain examples, be encoded with instructions that may, when executed in hardware, perform a process. The process may include a method that may configure one or more beam pairs for PDCCH based upon a corresponding downlink RS for beam management. The process may include a method that may assign one or more user equipment beams which correspond to one or more configured beam pairs, based on one or more corresponding downlink RS for beam management. The process may include a method that may, upon detecting a PDCCH within a search space candidate with a particular port or ports, identify one or more default beam pairs, based on one or more corresponding downlink RS for beam management, within the PDCCH search space candidates. The process may include a method that may evaluate path loss for PUCCH transmission based upon the one or more RS corresponding to the one or more beam pairs.

In accordance with an example, a computer program product may, according to certain examples, have instructions encoded for performing a process. The process may include a method that may configure one or more beam pairs for PDCCH based upon a corresponding downlink RS for beam management. The process may further include a method that may assign one or more user equipment beams which correspond to one or more configured beam pairs, based on one or more corresponding downlink RS for beam management. The process may further include a method that may, upon detecting a PDCCH within a search space candidate with a particular port or ports, identify one or more default beam pairs, based on one or more corresponding downlink RS for beam management, within the PDCCH search space candidates. The process may further include a method that may evaluate path loss for PUCCH transmission based upon the one or more RS corresponding to one or more beam pairs.

In accordance with an example, an apparatus may include circuitry configured to configure one or more beam pairs for PDCCH based upon a corresponding downlink RS for beam management. The apparatus may further include circuitry configured to assign one or more user equipment beams which correspond to one or more configured beam pairs, based on one or more corresponding downlink RS for beam management. The apparatus may further include circuitry configured to, upon detecting a PDCCH within a search space candidate with a particular port or ports, identify one or more default beam pairs, based on one or more corresponding downlink RS for beam management, within the PDCCH search space candidates. The apparatus may further include circuitry configured to evaluate path loss for PUCCH transmission based upon the one or more RS corresponding to the one or more beam pairs.

In accordance with an example, a method may include configuring one or more beam pairs for PDCCH based upon a corresponding downlink RS for beam management. The method may also include assigning one or more user equipment beams which correspond to one or more configured beam pairs, based on one or more corresponding downlink RS for beam management. The method may also include, upon detecting a PDCCH within a search space candidate with a particular port or ports, identifying one or more default beam pairs, based on one or more corresponding downlink RS for beam management, within the PDCCH search space candidates. The method may also include evaluating path loss for PUCCH transmission based upon the one or more RS corresponding to the one or more beam pairs.

In a variant, a UE beam of the one or more configured PDCCH beam pairs may be assigned to and/or configured with one or more PDCCH search space candidates.

In a variant, if only a single port corresponding to a beam pair is detected, UE evaluates and determines the path loss based upon a beam management RS, wherein a beam management RS may represent a detected beam pair.

In a variant, if multiple ports corresponding to multiple beam pairs are detected, UE evaluates and determines the path loss based upon a beam management RS, wherein the beam management RS represents the detected beam pair with the largest path loss.

### BRIEF DESCRIPTION OF THE DRAWINGS

For a proper understanding of this disclosure, reference should be made to the accompanying drawings, wherein:

FIG. 1 illustrates a system according to certain embodiments.

FIGS. 2a and 2b illustrate example data structures.

FIG. 3 illustrates an example of a signal flow diagram according to certain embodiments.

FIG. 4 illustrates an example of a system according to certain embodiments.

FIG. 5 illustrates another example of a system according to certain embodiments.

FIG. 6 illustrates an example of a method performed by a network entity according to certain embodiments.

FIG. 7 illustrates an example of another method performed by a network entity according to certain embodiments.

FIG. 8 illustrates an example of another method performed by a network entity according to certain embodiments.

FIG. 9 illustrates an example of another method performed by a network entity according to certain embodiments.

### DETAILED DESCRIPTION

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

Certain embodiments contained herein may have various benefits and/or advantages. For example, certain embodiments may provide a power control scheme of a PUCCH where beam uncertainty exists by applying a beam diversity scheme for PDCCH.

A UE beam for PDCCH blind detection may be configured for each PDCCH search space candidate. A gNB beam may be configured with a UE beam for PDCCH transmissions. The configuration of a gNB beam and UE beam together may form a beam pair. When multiple beam pairs are configured within a single PDCCH search space candidate, such as multiple gNB beams being paired with the same UE beam, a default beam pair may be configured that enables the measurement and/or calculation of signal path loss. In some embodiments, a beam pair may be configured as the default beam pair if it results in the highest and/or lowest path loss, such as propagation loss minus the beam gain. In some embodiments, when the UE detects PDCCH within a certain search space, the UE may assume that the path loss for PUCCH power control may be measured based on the reference signal (RS) that represents the default gNB beam and UE beam pair.

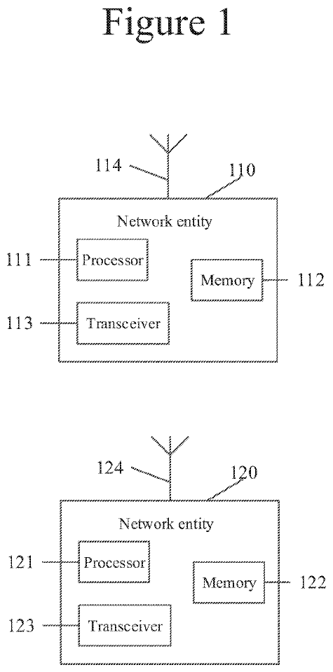

FIG. 1 illustrates a system according to certain embodiments. In one embodiment, a system may include multiple devices, such as, for example, network entity 110 and 120. Network entity 110 and 120 may include one or more user equipment (UE) and/or a next generation node B (gNB). A network entity may also include a next generation radio access network, mobility management entity, serving gateway, base station, such as an evolved node B, a server, and/or other access node.

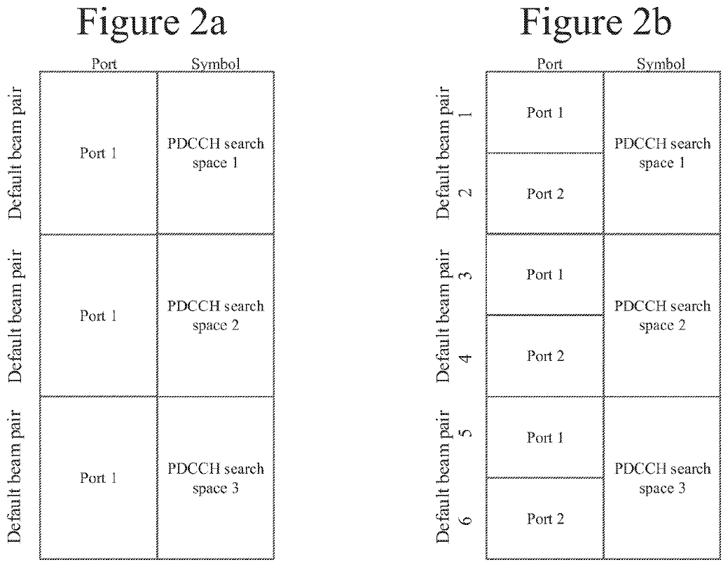

One or more of these devices may include at least one processor, respectively indicated as 111 and 121. At least one memory may be provided in one or more of devices indicated at 112 and 122. The memory may be fixed or removable. The memory may include computer program instructions or computer code contained therein. Processor 111, 121 and memory 112, 122, or a subset thereof, may be configured to provide means corresponding to the various blocks of FIGS. 2-9. Although not shown, the devices may also include positioning hardware, such as global positioning system (GPS) or micro electrical mechanical system (MEMS) hardware, which may be used to determine a location of the device. Other sensors are also permitted and may be included to determine location, elevation, orientation, and so forth, such as barometers, compasses, and the like.

As shown in FIG. 1, transceiver 113 and 123 may be provided, and one or more devices may also include at least one antenna, respectively illustrated as 114 and 124. The device may have many antennas, such as an array of antennas configured for multiple input multiple output (MIMO) communications, or multiple antennas for multiple radio access technologies. Other configurations of these devices, for example, may be provided.

Transceiver 113 and 123 may be a transmitter, a receiver, or both a transmitter and a receiver, or a unit or device that may be configured both for transmission and reception.

Processor 111 and 121 may be embodied by any computational or data processing device, such as a central processing unit (CPU), application specific integrated circuit (ASIC), or comparable device. The processors may be implemented as a single controller, or a plurality of controllers or processors.

Memory 112 and 122 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory and which may be processed by the processors may be any suitable form of computer program code, for example, a compiled or interpreted computer program written in any suitable programming language.

The memory and the computer program instructions may be configured, with the processor for the particular device, to cause a hardware apparatus such as user equipment or a gNB to perform any of the processes described below (see, for example, FIGS. 2-9). Therefore, in certain embodiments, a non-transitory computer-readable medium may be encoded with computer instructions that, when executed in hardware, perform a process such as one of the processes described herein. Alternatively, certain embodiments may be performed entirely in hardware.

FIGS. 2a and 2b illustrate example data structures. For example, in some embodiments, a Physical Downlink Control Channel (PDCCH) search space matrix may include one port (FIG. 2a) or multiple ports (for example, 2 ports in FIG. 2b) for each PDCCH search space. However, any number of ports may be configured for each PDCCH search space, and each PDCCH search space may have a different number of ports than other PDCCH search spaces. Each row in the matrix represents a default beam pair, with each pair being associated with one or more beams in one or more ports. In some embodiments, during hybrid beamforming, one or more ports may be configured per panel depending on antenna polarization. In some embodiments, a PDCCH search space may be associated with one or more ports.

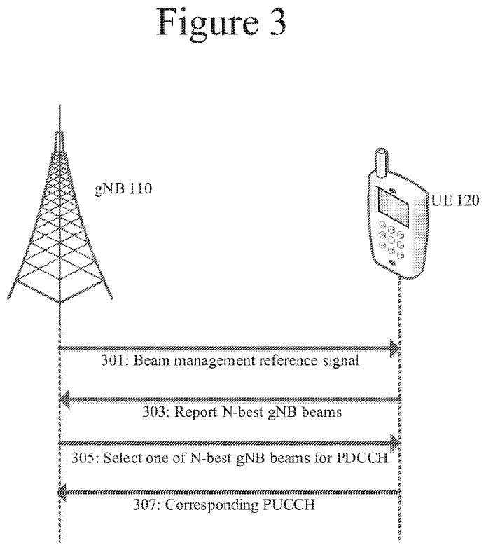

FIG. 3 illustrates an example of a signal flow diagram according to certain embodiments. In step 301, gNB 110 transmits a beam management RS to UE 120. In step 303, UE 120 transmits a report to gNB 110, wherein the report contains one or more gNB beams. In some embodiments, the one or more gNB beams identify the one or more beams with the highest and/or lowest path loss. In step 305, gNB 110 transmits one or more of the one or more beams identified by UE 120 to UE 120 for use in PDCCH. In step 307, UE 120 transmits corresponding PUCCH to gNB 110.

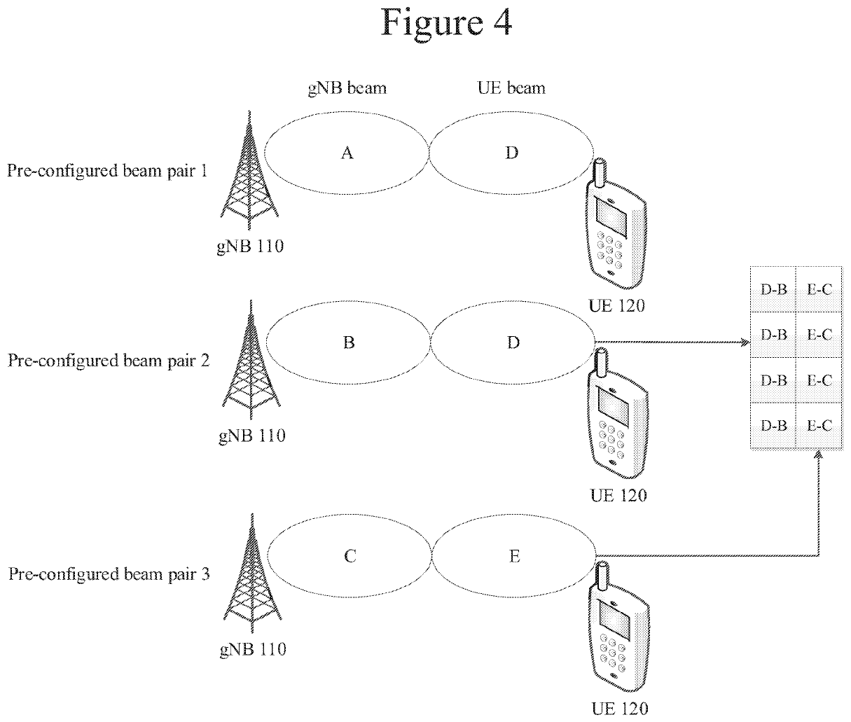

FIG. 4 illustrates an example of a system according to certain embodiments. For example, pre-configured beam pair 1 may use a combination of gNB beam A and UE beam D in communication between gNB 110 and UE 120. Pre-configured beam pair 2 may use a combination of gNB beam B and UE beam D between gNB 110 and UE 120. Pre-configured beam pair 3 may use a combination of gNB beam C and UE beam E between gNB 110 and UE 120. Within the PDCCH search space matrix, beam pair D-B may be assigned as the default beam pair for one or more of the PDCCH search space candidates, and beam pair E-C may be assigned as the default beam pair for the other candidate of a PDCCH search space. In some embodiments, a UE beam is configured for each PDCCH search space candidate. In some embodiments, one or more default beam pairs are configured for each PDCCH search space candidate.

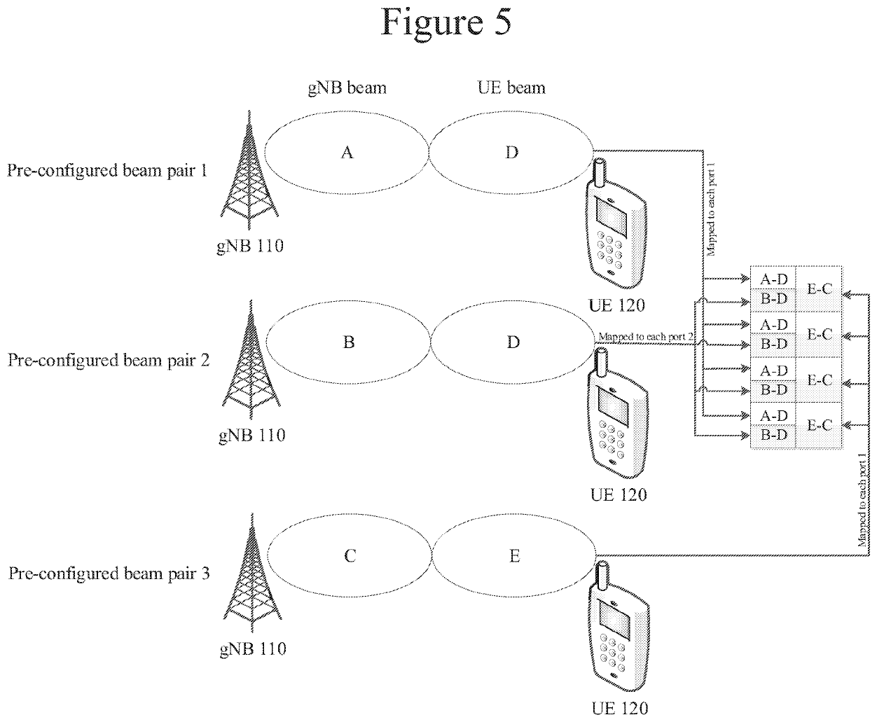

FIG. 5 illustrates another example of a system according to certain embodiments. For example, pre-configured beam pair 1 may use a combination of gNB beam A and UE beam D in communication between gNB 110 and UE 120. Pre-configured beam pair 2 may use a combination of gNB beam B and UE beam D between gNB 110 and UE 120. Pre-configured beam pair 3 may use a combination of gNB beam C and UE beam E between gNB 110 and UE 120. Each PDCCH search space may be associated with one or more ports, where each port is associated with a default beam pair. For example, beam pair A-D may be assigned as the default beam pair in port 1, while beam pair B-D may be assigned as the default beam pair in port 2, and beam pair E-C may be assigned as the default beam pair for the other candidate of a PDCCH search space. However, any beam associated with a beam pair may be assigned to any port.

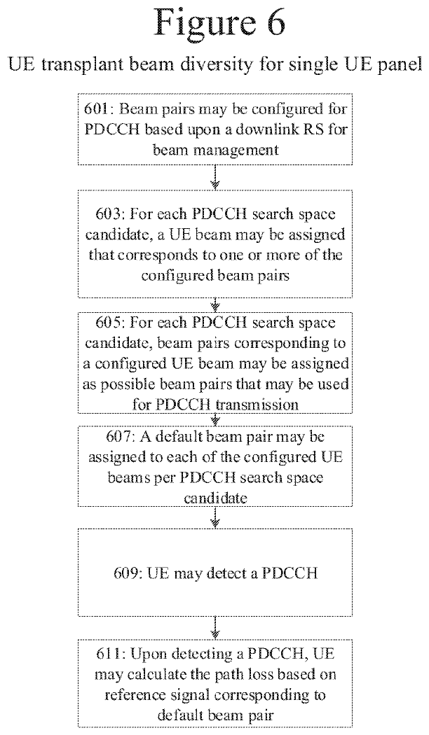

FIG. 6 illustrates an example method of UE transparent beam diversity with a single UE beam port. In step 601, beam pairs may be configured for PDCCH based upon a downlink reference signal for beam management. In step 603, for each PDCCH search space candidate, a UE beam may be assigned that corresponds to one or more of the configured beam pairs. For example, a UE beam of the one or more configured PDCCH beam pairs may be assigned to and/or configured with one or more PDCCH search space candidates.

In step 605, for each PDCCH search space candidate, beam pairs corresponding to a configured UE beam may be assigned as possible beam pairs that may be used for PDCCH transmission.

In step 607, a default beam pair may be assigned to each of the configured UE beams per PDCCH search space candidate from the assigned beam pairs. For example, a beam pair which provides the smallest and/or largest path loss may be assigned as a default beam pair. In step 609, a UE may detect a PDCCH. In step 611, upon detecting a PDCCH, UE may identify a default beam pair within the PDCCH search space candidate, and/or the UE may measure and/or calculate the path loss based on the downlink beam measurement reference signals which correspond to the default beam pair of the detected PDCCH search space candidate.

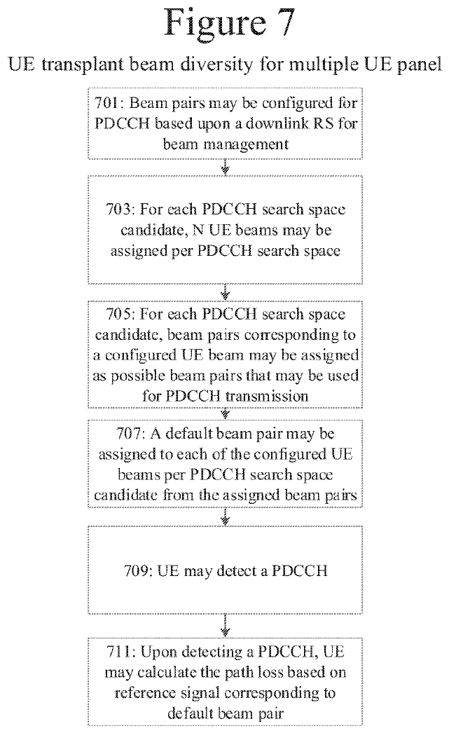

FIG. 7 illustrates an example method of UE transparent beam diversity with a multiple UE beam port. In step 701, beam pairs may be configured for PDCCH based upon a downlink RS for beam management. In step 703, for each PDCCH search space candidate, N UE beams may be assigned per PDCCH search space, and each UE beam may correspond to one or more of the configured beam pairs, where N is equal to or less than the number of ports in a UE.

In step 705, for each PDCCH search space candidate, beam pairs corresponding to a configured UE beam may be assigned as possible beam pairs that may be used for PDCCH transmission.

In step 707, a default beam pair may be assigned to each of the configured UE beams per PDCCH search space candidate from the assigned beam pairs. For example, a beam pair which provides the smallest and/or largest path loss may be configured as a default beam pair. In step 709, UE may detect a PDCCH. In step 711, upon detecting a PDCCH, UE may identify a default beam pair within the PDCCH search space candidate, and the UE may measure and/or calculate the measured path loss based on the downlink beam measurement RS which corresponds to the default beam pair of detected PDCCH search space candidate.

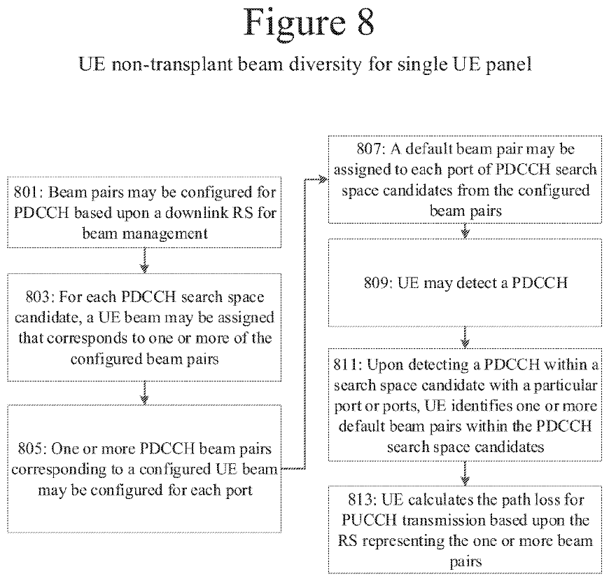

FIG. 8 illustrates an example method of UE non-transparent beam diversity with a single UE beam panel. When UE is configured to use non-transparent beam diversity, multiple RS ports may be used for channel compensation, and different beams may be mapped to different RS ports. In step 801, beam pairs may be configured for PDCCH based upon a downlink RS for beam management. In step 803, for each PDCCH search space candidate, a UE beam may be assigned that corresponds to one or more of the configured beam pairs. For example, one or more UE beams of the one or more configured PDCCH beam pairs may be assigned to and/or configured with one or more PDCCH search space candidates.

In step 805, one or more PDCCH beam pairs corresponding to a configured UE beam may be configured for each port.

In step 807, a default beam pair may be assigned to each port of PDCCH search space candidates from the configured beam pairs. In step 809, UE may detect a PDCCH. In step 811, upon detecting a PDCCH within a search space candidate with a particular port or ports, UE identifies one or more default beam pairs within the PDCCH search space candidates.

In step 813, UE calculates the path loss for PUCCH transmission based upon the RS representing the one or more beam pairs. In some embodiments, if only a single port corresponding to a beam pair is detected, UE evaluates and determines the path loss based upon a beam management RS, wherein a beam management RS may represent a detected beam pair. In some embodiments, if multiple ports corresponding to multiple beam pairs are detected, UE evaluates and determines the path loss based upon a beam management RS, wherein the beam management RS represents the detected beam pair with the largest path loss.

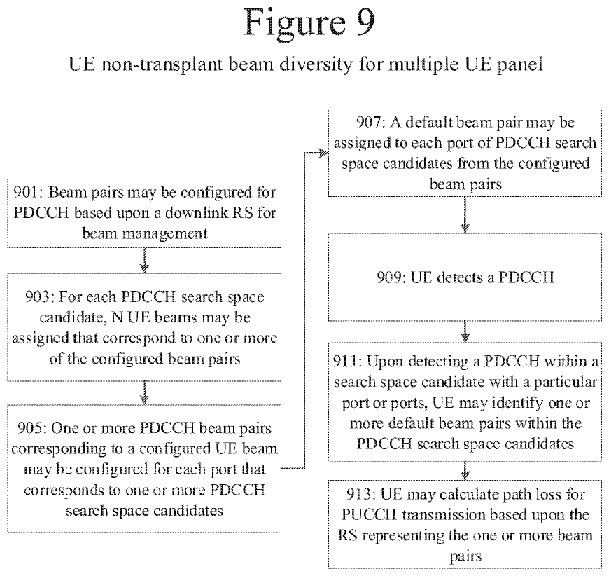

FIG. 9 illustrates an example method of UE non-transparent beam diversity with a multiple UE beam panel. In step 901, beam pairs may be configured for PDCCH based upon a downlink RS for beam management. In step 903, for each PDCCH search space candidate, N UE beams may be assigned per PDCCH search space, and each UE beam corresponds to one or more of the configured beam pairs, where N is equal to or less than the number of ports at a UE.

In step 905, one or more PDCCH beam pairs corresponding to a configured UE beam may be configured for each port.

In step 907, a default beam pair may be assigned to each port of PDCCH search space candidates from the configured beam pairs. In step 909, UE may detect a PDCCH. In step 911, upon detecting a PDCCH within a search space candidate with a particular port or ports, UE may identify one or more default beam pairs within the PDCCH search space candidates.

In step 913, UE may calculate path loss for PUCCH transmission based upon the RS representing the one or more beam pairs. In some embodiments, if only a single port corresponding to a beam pair is detected, UE evaluates and determines the path loss based upon a beam management RS, wherein a beam management RS may represent a detected beam pair. In some embodiments, if multiple ports corresponding to multiple beam pairs are detected, UE evaluates and determines the path loss based upon a beam management RS, wherein the beam management RS represents the detected beam pair with the largest path loss.

One having ordinary skill in the art will readily understand that certain embodiments discussed above may be practiced with steps in a different order, and/or with hardware elements in configurations which are different than those which are disclosed. Therefore, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### PARTIAL GLOSSARY

3GPP 3^{rd} Generation Partnership Project

CSI Channel State Information

DCI Downlink Control Information

eNB evolved Node B

gNB Next Generation Node B

LTE Long-Term Evolution

NR New Radio

PDCCH Physical Downlink Control Channel

PUCCH Physical Uplink Control Channel

RAN Radio Access Network

RS Reference Signal

UCI Uplink Control Information

UE User Equipment

1-30. (canceled)

31. An apparatus comprising:
at least one processor; and
at least one memory including computer program code,
wherein the at least one memory and the computer program code are configured to, with the at least one processor, cause the apparatus to:
configure one or more beam pairs for physical downlink control channel, PDCCH, based upon one or more corresponding downlink reference signal, RS, for beam management, wherein the one or more beam pairs comprises a user equipment, UE, beam;
identify one or more default beam pairs from the configured one or more beam pairs, based on the one or more corresponding downlink RS for beam management, within a PDCCH search space candidate; and
evaluate path loss for physical uplink control channel, PUCCH, transmission based upon the one or more downlink RS corresponding to the identified one or more default beam pairs.

32. The apparatus according to claim 31, wherein the UE beam of the one or more configured beam pairs, based on one or more corresponding downlink RS for beam management, is assigned to and/or configured with one or more PDCCH search space candidates.

33. The apparatus according to claim 31, wherein:
if only a single port corresponding to a configured beam pair is detected, when evaluating the path loss, the at least one memory and the computer program code are configured to, with the at least one processor, cause the apparatus to evaluate the path loss based upon the downlink RS corresponding to the identified default beam pair.

34. The apparatus according to claim 31, wherein:
if multiple ports corresponding to multiple configured beam pairs are detected, when evaluating the path loss, the at least one memory and the computer program code are configured to, with the at least one processor, cause the apparatus to evaluate the path loss based upon the downlink RS corresponding to the identified default beam pair with the smallest or the largest path loss.

35. A method comprising:
configuring one or more beam pairs for physical downlink control channel, PDCCH, based upon one or more corresponding downlink reference signal, RS, for beam management, where in the one or more beam pairs comprises a user equipment, UE, beams;
identifying one or more default beam pairs from the configured one or more beam pairs, based on the one or more corresponding downlink RS for beam management, within a PDCCH search space candidate; and
evaluating path loss for physical uplink control channel, PUCCH, transmission based upon the one or more RS corresponding to the identified one or more default beam pairs.

36. The method according to claim 35, wherein the UE beam of the one or more configured beam pairs, based on one or more corresponding downlink RS for beam management, is assigned to and/or configured with one or more PDCCH search space candidates.

37. The method according to claim 35, wherein:
if only a single port corresponding to a configured beam pair is detected, the evaluating of path loss comprises evaluating the path loss based upon the downlink RS corresponding to the identified default beam pair.

38. The method according to claim 35, wherein:
if multiple ports corresponding to multiple configured beam pairs are detected, the evaluating of path loss comprises evaluating the path loss based upon the downlink RS corresponding to the identified default beam pair with the smallest or largest path loss.

39. A non-transitory computer-readable medium encoding instruction for communication that, when executed in hardware, perform:
configuring one or more beam pairs for physical downlink control channel, PDCCH, based upon one or more corresponding downlink reference signal, RS, for beam management, where in the one or more beam pairs comprises a user equipment, UE, beams;
identifying one or more default beam pairs from the configured one or more beam pairs, based on the one or more corresponding downlink RS for beam management, within a PDCCH search space candidate; and
evaluating path loss for physical uplink control channel, PUCCH, transmission based upon the one or more RS corresponding to the identified one or more default beam pairs.
